(19) United States
(12) Patent Application Publication
(10) Pub. No.: US 2008/0208380 A1
(43) Pub. Date: Aug. 28, 2008

(54) MANUFACTURING STATION WITH IMPROVED CONTROLLER

(76) Inventor: Samir K. Taylor, Rochester Hills, MI (US)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 12/035,880

(22) Filed: Feb. 22, 2008

Related U.S. Application Data
(60) Provisional application No. 60/902,724, filed on Feb. 22, 2007.

(51) Int. Cl. G06F 17/00

(52) U.S. Cl. 700/108

(57) ABSTRACT

A manufacturing station comprises a tool which performs a manufacturing operation on a part, a controller programmed by a product line which controls the tool to determine that the operation is carried out, which receives information about the manufacturing operation and communicates information about the operation, and an interface between the tool and the controller, wherein the controller is configurable to one of a multiple of manufacturing operations which correspond to the product line of the controller.

### RELATED APPLICATION

This application claims priority benefit of U.S. Provisional Patent Application 60/902,724 filed on Feb. 22, 2007.

### FIELD OF THE INVENTION

This invention relates to a manufacturing station having an improved controller, and more particularly to a menu driven configurable controller for a tooling assembly for manufacturing stations such as those found in large scale manufacturing operations.

### BACKGROUND OF THE INVENTION

Manufacturing facilities use a variety of machines and tools to help assemble components or parts into a finished product. Known assembling operations typically break up steps of assembly into one or more manufacturing stations. For example, fastening tools are used to connect components together using bolts or screws. Fastening tools can tie the bolt tightening strategies to the part entering a manufacturing station. An assembly cycle begins when a part enters a given manufacturing station and ends when the part exits the manufacturing station. A representative assembly cycle can be characterized as follows:

The part enters the station. A tool such as a rivet gun or screw gun is mounted on a support member. Next, a part identification (Part ID) is sent to the fastening tool via a barcode, RFID system, Programmable Logic Controller (PLC) or plant network, etc. Where PLC is used, a fastening strategy is predetermined. An operator uses the fastening tool to tighten a bolt or screw. Sensors on the support member measure if the tightening was complete and within acceptable limits. The controller (PLC) sends a signal to allow the part to exit and the assembled product or finished product exits the manufacturing station.

Known examples of spatial positioning apparatus and support members include, for example, U.S. Pat. No. 7,040,196 to Ormachea et al. Ormachea et al uses programmable logic controllers (“PLC”) to handle the complexities introduced by operational variations. A fastening tool is attached to a support member that rides on a structure adjustable in an x-y-z direction. A light-box and touch screen panel provide operator interface with the controller. PLC ladder logic is written to the controller to interface with proximity sensors, relays, panel view user interface, network systems and light-box to manage and control the manufacturing station. The assembly operation relies on the operator to male at least the following decisions: choose the right tightening order, manually make sure all bolts are tightened (do not miss a bolt), and tighten with the right orientation.

Such known manufacturing assemblies work reasonably well but have several limitations. For example, when the number of tightening operations performed is greater than one, complexity for controlling count and order increases. That is, it can be difficult to know for sure whether all operations have been performed. Similarly, complexity increases when the size of the bolt or screw is different, when tightening strategies for the bolt or screw is different, or when a specific tightening sequence needs to be followed. Further, repair jobs require several un-fastenings and re-fastenings. Such known tooling assemblies are limited in their ability to achieve 100% error proofing. Also, sensors mounted on the support member do not provide direct information about tool position, and the support member in Ormachea et al only allows three degrees of freedom, but do not allow for pitch, yaw and roll.

Moreover, known manufacturing station controllers require high customization in ladder logic programming for every station. This requires extensive reprogramming for each new application, a process which can take several weeks and is expensive. In addition to the significant cost associated with customization, known manufacturing assemblies are limited in the types and variety of parts that can error-proofed due to the limited sensor resolution between bolts or screws. Higher level of complexity cannot be handled when the number of bolts is greater than three or when multiple tools are required or multiple parts need to be processed in the same assembly station. Thus, PLC ladder logic implementation to handle part complexity grows undesirably complex, tools may not be controllable in a desired orientation. Such known manufacturing stations are limited in their intended applications, not easily reconfigurable to other applications, and are expensive to acquire, install and maintain.

It would be desirable to provide a manufacturing station which can be readily reconfigured to work with a variety of product lines with enhanced functions, have reduced error rates and have greater assurances of reduced errors.

### SUMMARY OF THE INVENTION

In accordance with a first aspect, a manufacturing station comprises a tool which performs a manufacturing operation on a part, a controller programmed by a product line which controls the tool to determine that the manufacturing operation is carried out, which receives information about the operation ad communicates information about the operation, and an interface between the tool and the controller, wherein the controller is configurable to one of a multiple of manufacturing operations which correspond to the product line of the controller.

From the foregoing disclosure and the following more detailed description of various preferred embodiments it will be apparent to those skilled in the art that the present invention provides a significant advance in the technology and art of tooling assemblies for manufacturing stations. Particularly significant in this regard is the potential the invention affords for providing a high quality, low cost, tooling assembly for a manufacturing station readily adaptable to numerous design constraints. Additional features and advantages of various preferred embodiments will be better understood in view of the detailed description provided below.

### BRIEF DESCRIPTION OF THE DRAWINGS

FIG. 1 is a representative list of product lines or modules which can be specifically tailored for a unique manufacturing station.

FIG. 2 is a schematic diagram of an improved manufacturing station in accordance with a preferred embodiment, showing interconnections between a controller and other components.

FIG. 3 is a schematic view of a manufacturing station in accordance with a preferred embodiment, where the product line is a fastening module which controls application of fasteners to a manufactured product using a tool having 6 degrees of freedom.

FIG. 4 shows a representative display screen in normal default mode, or run mode, awaiting a part to be introduced to the station or awaiting setup commands which tailor the controller for a specific assembly operation at the station.

FIG. 5 shows a screen in the setup mode where the controller may be configured.

FIG. 6 shows a representative display screen presentation in a job mode where the operation to be performed is position setup and the product line is Fastening.

FIG. 7 shows a representative display screen presentation in a job mode where the manufacturing operation to be performed is position identification and the product line is Vision.

FIG. 8 shows a representative display screen presentation in a maintenance mode, showing a series of indicators corresponding to the status of digital inputs and outputs on the tooling assembly.

It should be understood that the appended drawings are not necessarily to scale, presenting a somewhat simplified representation of various preferred features illustrative of the basic principles of the invention. The specific design features of the manufacturing station as disclosed here will be determined in part by the particular intended application and use environment. Certain features of the illustrated embodiments have been enlarged or distorted relative to others to help visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved tooling assembly disclosed here. The following detailed discussion of various alternative and preferred features and embodiments, unless otherwise mentioned, will illustrate the general principles of the invention with reference to a manufacturing station suitable for use in a fastening operation. Other embodiments suitable for other applications will be apparent to those skilled in the art given the benefit of this disclosure.

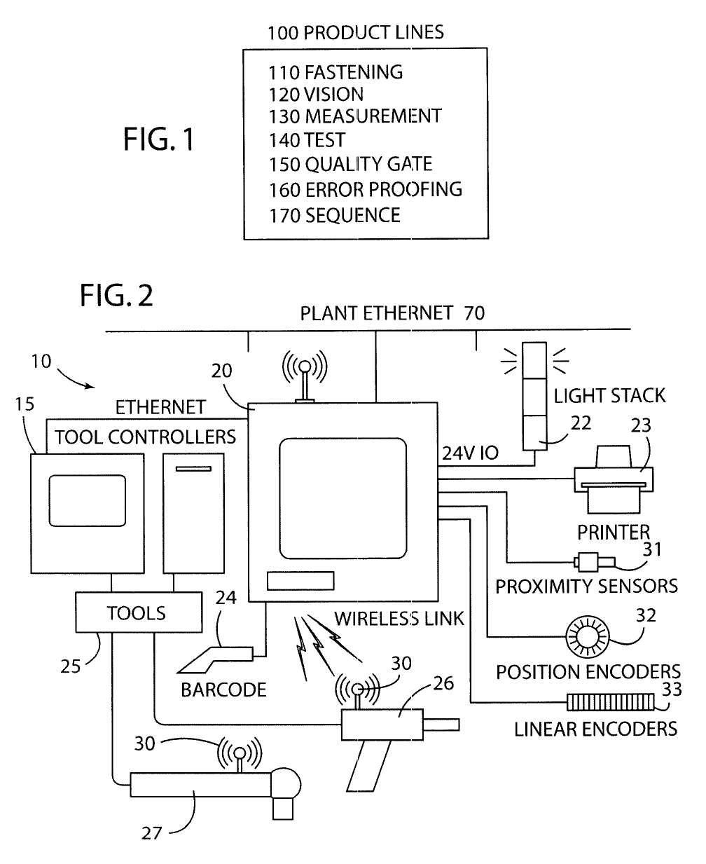

FIG. 1 shows a list of product lines or modules which may be implemented in a manufacturing operation. A fastening module 110 is used when the operation to be performed comprises assembling two parts together, such as with screws, rivets, welding, snap fit, etc. Vision module 120 is used to confirm a color match between two parts, or to make sure two parts are aligned properly. Measurement module 130 may be used when measuring and confirming the measurement of a part. Test module 140 may be used to test a product and confirm that it works as intended. Quality Gate module 150 may be used, for example, to gather real time information, such as at the end of a manufacturing line to confirm that parts are properly packed, scan for a bar code, etc. Error Proofing module 160 may be used to confirm, for example that two parts used to form an assembly are in fact, actually connected together, not merely present. Sequence Module 170 may be used to assure that parts are assembled or packed in an appropriate order. Each module corresponds to a particular manufacturing operation. Other modules suitable for use in a manufacturing station will be readily apparent to those skilled in the art given the benefit of this disclosure. Each of these modules may be performed at a separate manufacturing station. Alternatively, more than one module may be used at a given manufacturing station. As understood herein, the term manufacturing operation refers to a step or series of steps controlled by a module at a manufacturing station. Thus, for the fastening product line, a manufacturing operation can comprise applying several fasteners to secure two components together to form a part, for the vision product line, a manufacturing operation can comprise inspection of the part to confirm that it is present and/or that it has correct dimensions.

In accordance with a highly advantageous feature the controller uses state machine programming. That is, instead of using a programmable logic control (PLC) with ladder logic, state machine is used. This greatly increases flexibility and adaptability of the tool assembly. Given the need for extensive, cumbersome reprogramming, PLC based systems would take several weeks to change over to a different module (also including changes in hardware, sensors, tools, etc.) whereas switching tooling assemblies to accommodate a different module can take just hours to complete. The controller disclosed herein is readily configurable for different operations. This configuration may be accomplished by inputting data at display screens, most preferably touch screens, instead of tedious reprogramming for each operation. Preferably display screens which can receive inputs via touch screens are provided for each module. Modules may be used in combination, sequentially, or in isolation, depending on a manufacturer's requirements. The controller used herein can advantageously reduce the number of manufacturing stations required in an assembly line by managing multiple parts at the same station.

As an example of the use of a module for fastening, FIG. 2 shows a schematic diagram of an improved manufacturing station 10 in accordance with a preferred embodiment, showing interconnections between the (controller 15 and other components of the manufacturing station. Tools 26, 27 are each provided with a sensor 30 mounted directly on the tool. The controller 15 is electrically connected to a display 20, most preferably a touch screen display which allows for easy reconfiguration from one operation to another, or to an identical operation on a different set of components (such as fasteners in different locations). The display can show control messages devices remote from the controller. Also, the controller may be connected to a printer 31 to allow for paper copies of data about the manufacturing operation to be printed.

An assembly operator uses one of various tools 25, such as screw gun 26 or rivet gun 27 that is freely movable or rigidly held. When a vision module is used, the tool may comprise, for example, a camera. Fastening tools can be broadly categorized into “pistol tools” that are pistol shaped and are held with one hand, and “lever tools” which are straight tools that generally require two-handed operation. The tool may be held mechanically to absorb tool reaction and restrict movement. The location sensors are selected based on the application. Various types of location sensors can be used, including, for example proximity sensors 31; rotary encoders 32 for x-y position; rotary and linear encoders 33 for x-y-z; orientation sensors for pitch-yaw-roll; and 6-degree of freedom sensors for x-y-z-and pitch-yaw-roll. Preferably these position sensors measure position with respect to a reference point. Bar coder scanners 24 and light stack 22 may be provided where needed.

In accordance with a highly advantageous feature, data may be transmitted to and received from a device remote from the manufacturing station and from the controller via a plant ethernet 70. The plant ethernet is a family of frame-based computer networking technologies for local area networks (LANs). This is advantageous as data about the operation performed at multiple manufacturing stations may be sent not just to a display proximate the manufacturing station but also to a command center and monitored, for example. Additionally, commands may be issued by the command center and sent to each controller such as, for example, and emergency shut down.

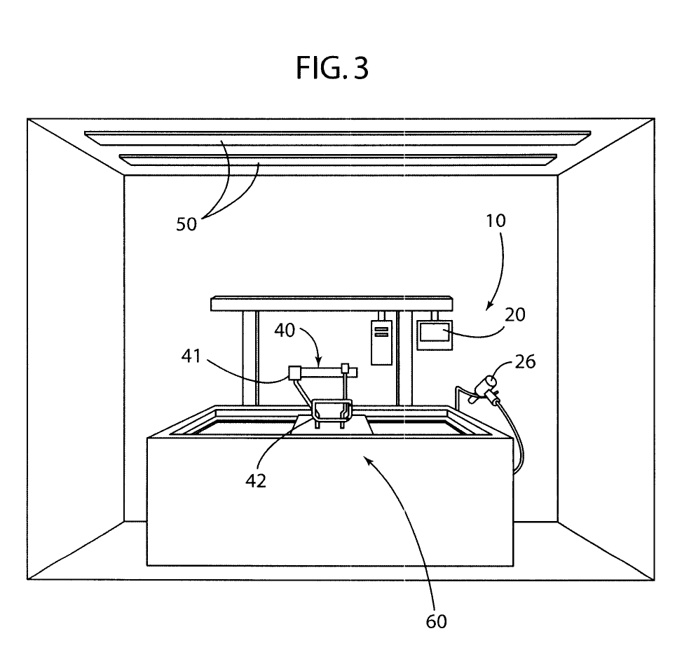

FIG. 3 shows an assembly area 60 where two components 41 and 42 are fastened together to form a part 40. The configurable product line used would be the fastening module 110. The tool used here is a screw gun 26, mounted on the manufacturing station generally adjacent the location where the components 41, 42 are fastened together into part 40. Tool adaptors can be specially designed, depending on the tool used.

Preferably the sensors are wirelessly connected to the controller via receivers 50 so as to allow essentially instantaneous feedback to one of the displays 20, 55. Where the tool is a fastening device such as a screw gun 26, most preferably, the sensor used is a six degree-of-freedom sensor mounted directly on the tool. Most preferably a six-degree of freedom ultrasound based spatial tracking system is used. The ultrasound receivers 50 are placed generally adjacent the manufacturing station 60. As shown in FIG. 3 they are above the station. The receivers may also be implemented as pods depending on the application. This system advantageous allows an operator freedom of movement while still ensuring that the fasteners are applied properly.

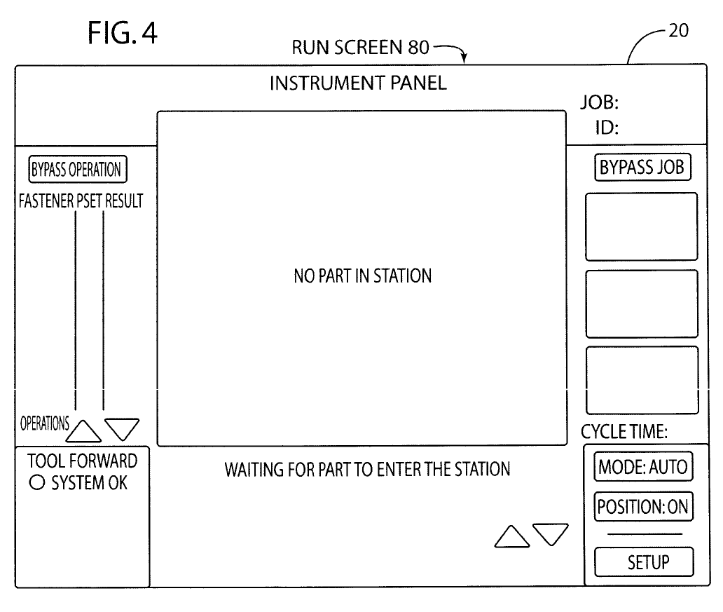

A controller 15 using the fastening module 110 manages and controls the operation performed at this manufacturing station 60 The sensors provide part or all position and orientation information to the controller 15. The controller integrates position and orientation data with desired assembly process to error-proof operation by applying a correct control strategy, counting operations and forcing order of application. A user interface is designed to allow configuration in a simple step-by-step manner without the requirement of specialized programming skills through the used of a series of displays on the touch screen 20. FIG. 4 shows a representative default run screen 80 on the display 20 where no part is current at the manufacturing station. A default run screen such as the one presented here may be used in any of the product lines.

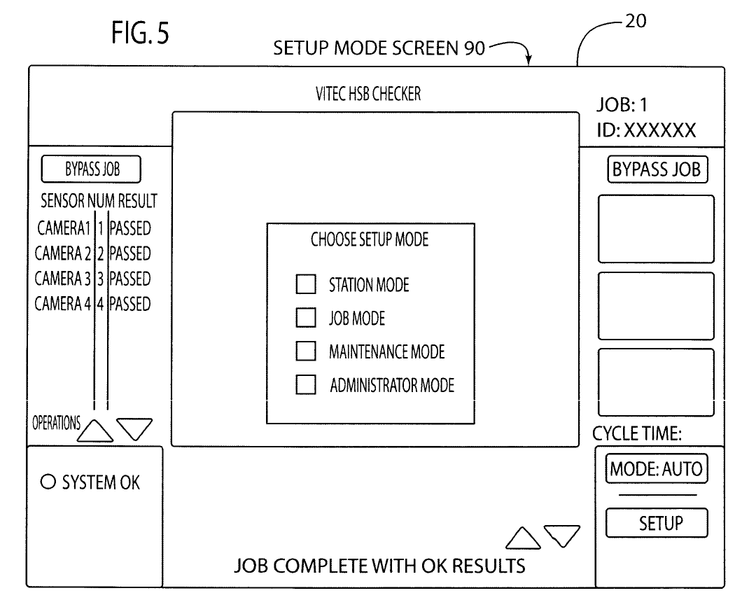

To configure the manufacturing station for a particular manufacturing operation using a selected product line, a user may touch a setup button on the default run screen 80, switching to a setup mode screen 90 shown in FIG. 5. The user is then presented with a series of setup mode options, including a Station Mode, where display screens identify information about the manufacturing station, including, for example, what tool will be used, how the tool is connected to the rest of the assembly, any calibration or sensor connection setup, the name of the station, and define basic user messages which can be shown on the display when a job is not in station. Another setup mode option is a Job mode, where the information about the part and the manufacturing operation to be performed are initially configured and can be readily reconfigured. Multiple jobs may be defined in the Job mode, also how to detect the job (with part identification or with digital input), add targets to the job, configure target related details such as, for example, the tool or test, a parameter set to use, the name of the job, any associated messages to the operator at the manufacturing station, select an image for the target (which may be obtained from an external or remote USB), configure the target position on the screen and its tolerance values. Another setup mode is a Maintenance mode, which presents information about the manufacturing tooling to confirm proper connections and operation, and an Administrator mode, where administrator screens can be set up, access can be set, passwords generated for different user roles (administrator, supervisor, maintenance and operator), etc., along with establishing different security levels for various function in the assembly.

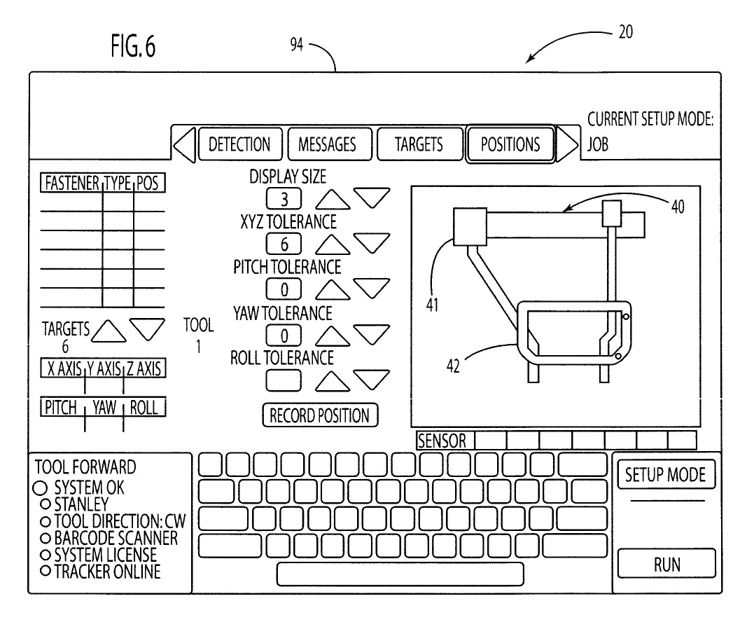

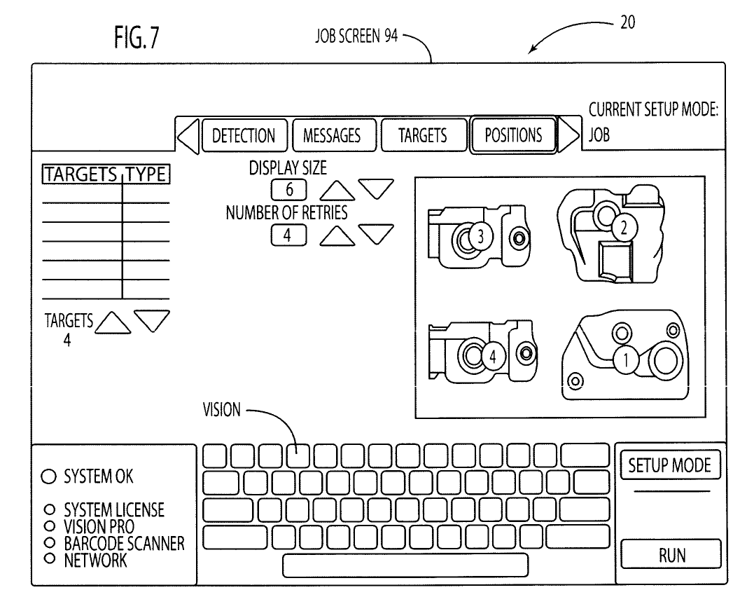

In the Job mode a set of instructions for the manufacturing operation is created an identified a part picture may be added, and the controller may be taught part location. For example, FIG. 6 shows a Job mode display screen 94 for the fastening product line 110. A part picture is added, arid two subcomponents 41, 24 are shown in the appropriate positions for attachment of screws. Using the 6-DOF sensors allows the operator to know the position of the screw gun, and the position can be displayed and set for each screw to be used. That is, the tool may be moved to the bolt or screw location and a trigger is pressed to capture the position. The job is then tied to the part number.

When parts are moving through an assembly line to the manufacturing station, the display screen can show a picture of the job and flash the location for fasteners to be applied on the screen. Advantageously, with the sensor information provided to the controller comprises both position and angle of implementation of the tool with respect to the components to be assembled into a part. This allows the controller to control the angle the screw gun is applied to the components to prevent excessive tool offset from a correct angle of implementation. In operation, the controller can be set to determine not just a correct position for the screw gun, but also a correct angle of implementation. When the tool is moved to the correct position and correct angle the controller enables the tool with the correct tightening strategy and waits for the operator to run the tool. If at this time operator moves the tool away from the correct position or moves the tool away from the correct angle, the controller simply disables the tool. Thus, by controlling the tool orientation the controller thereby helps to prevent part damage due to tightening at a wrong angle. After each fastener is applied, the controller verifies that the tightening is good (within an acceptable range of torque, for example). Next the controller indicates that the bolt attachment step is complete on the display screen and directs the operator to move to the next bolt until all tightening is completed.

FIG. 7 shows a representative display screen presentation in a job mode where the manufacturing operation to be performed is position identification and the product line is Vision. As with the fastening module, a display screen can show a picture of the job and flash information for initial setup. Here, the initial information can comprise confirming that a part is present and that it is properly oriented, along with selecting a number of retries to confirm part status.

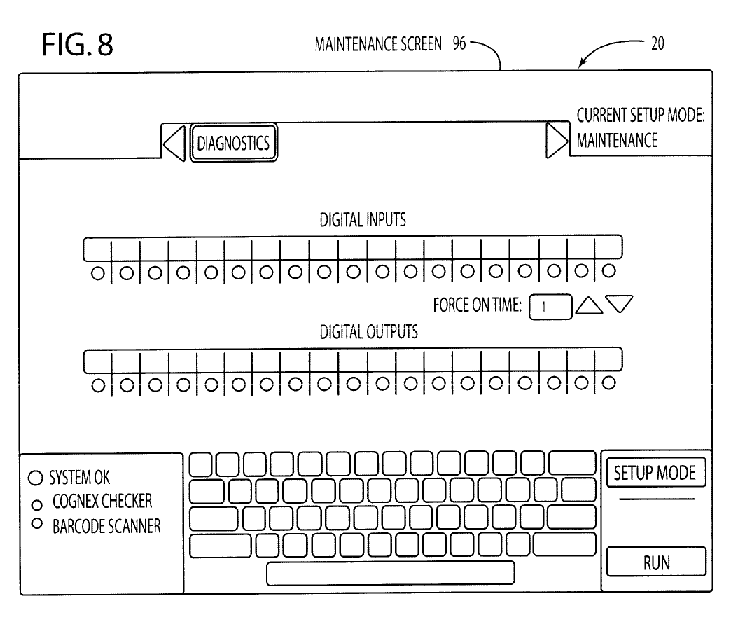

FIG. 8 is a representative display for a maintenance screen 96. Digital inputs and digital outputs corresponding to all of the electrical connections of the manufacturing station are represented on the screen. A colored light may appear, such as a green light for fully functional and normal, and a red light for an error. Different modules may use different digital inputs and outputs, so not all of these indicators may be used for a given module. Advantageously data about the job and the station, once created, may be stored and automatically backed and recoverable in case of power failure or other incapacity of the assembly.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A manufacturing station comprising, in combination:
a tool which performs a manufacturing operation on a part;
a controller programmed by a product line which controls the tool to determine that the operation is carried out, which receives information about the manufacturing operation and communicates information about the operation; and
an interface between the tool and the controller;
wherein the controller is configurable to one of a multiple of manufacturing operations which correspond to the product line of the controller.

2. The manufacturing station of claim 1 wherein the interface comprises a touchscreen display and the controller is configurable by touching the display; and
the display displays a job mode screen corresponding to each product line.

3. The manufacturing station of claim 2 wherein the display further comprises a setup screen and the job mode screen is one of the options available at the setup screen.

4. The manufacturing station of claim 3 wherein the setup screen displays choices for a station mode screen, the job mode screen, and a maintenance mode screen.

5. The manufacturing station of claim 1 wherein the information about the manufacturing operation is communicated to a display and to a device remote from the manufacturing station, and the controller can receive information from the remote device.

6. The manufacturing station of claim 5 wherein the information transmitted to the remote device comprises data about the operation, and information received from the remote device comprises control commands.

7. The manufacturing station of claim 1 wherein the interface comprises a display and a sensor which is one of a proximity sensor, a position encoder, a linear encoder and a six degree of freedom sensor.

8. The manufacturing station of claim 7 wherein the six degree of freedom sensor transmits information to a receiver located generally adjacent the tool.

9. The manufacturing station of claim 7 wherein the sensor is mounted directly on the tool.

10. The manufacturing station of claim 1 wherein the product line is one of fastening, vision, measurement, testing, quality gating, error proofing and sequence determination or a combination thereof.

11. The manufacturing station wherein the controller backups information about the manufacturing operation so that the information can be recovered later.

12. A manufacturing station comprising, in combination:
a tool which performs a manufacturing operation on a part, wherein the manufacturing operation is a fastening operation for fastening components together to form a part;
a controller which controls the tool to determine that the fastening operation is carried out and which communicates information about a status of the operation; and
an interface between the tool and the controller, comprising a sensor mounted directly on the tool which provides information about the position of the tool to the controller;
wherein the tool is free to move in any direction.

13. The manufacturing station of claim 12 wherein the sensor measures position in three dimensions and also measures pitch, yaw and roll of the tool with respect to a reference point.

14. The manufacturing station of claim 12 further comprising receivers which receive a signal from the sensor containing information about the position of the sensor and relay this information to the controller.

15. The manufacturing station of claim 12 wherein the controller is reconfigurable for a second, non-fastening manufacturing operation.

16. The manufacturing station of claim 15 wherein the controller communicates information about the manufacturing station via a plant Ethernet to a device remote from the manufacturing station.

17. The manufacturing station of claim 12 wherein the controller can be set to determine a correct position for the tool, and a correct angle of implementation of the tool to the components.

18. The manufacturing station of claim 17 wherein the tool can be disabled by the controller if the tool is not in the correct position or if the tool is not at the correct angle of implementation.
